(19) United States
(12) Patent Application Publication
(10) Pub. No.: US 2007/0179833 A1
(43) Pub. Date: Aug. 2, 2007

(54) Assisted business process exception management

(75) Inventors: Manohar Moorthy, Bangalore (IN); Srinivas Thonse, Bangalore (IN); Nagaraja Nanjegowda Siddaramappa, Bangalore (IN)

Correspondence Address: KLARQUIST SPARKMAN, LLP, 121 SW SALMON STREET, SUITE 1600, PORTLAND, OR, 97204, US

(73) Assignee: Infosys Technologies Ltd.

(21) Appl. No.: 11/344,740

(22) Filed: Jan. 31, 2006

(51) Int. Cl. G06Q 99/00; G07G 1/00; G06F 17/30

(52) U.S. Cl. 705/10; 705/1

(57) ABSTRACT

A computer-implemented method of handling exceptions in a business process is disclosed. In one embodiment, a business process exception is identified, classified as being at least one of a plurality of exception types, wherein the classification is based at least in part on a plurality of classification rules, and allocated to at least one user based at least in part on a plurality of allocation rules. The exception can then be investigated and resolved.

### TECHNICAL FIELD

The technical field relates to business process exceptions. More particularly, the field relates to management of exceptions encountered by business processes.

### BACKGROUND

Businesses have adopted Information Technology (IT) for automation from the early ages of computing. Starting with information storage in the 1950s, enterprises have adopted data processing, decision support systems, and automation packages like Enterprise Resource Planning (ERP) and Internet-delivered services. This has helped in improving the efficiency of the business and contributed to faster cycle times and other improvements.

In some industries, automation levels are high but, when exceptions (e.g., error conditions that can change the normal flow of a business process) occur, the handling is manual. A typical business process is a set of activities performed to achieve certain business objectives. When a business process exception occurs, expert human intervention is usually needed to resolve the exception. Most exception management systems are workflow systems that help in managing exceptions by assigning exceptions to experts but do not remove dependency on humans. These experts spend a significant amount of time to investigate and resolve a given exception and must refer to their prior knowledge of the business enterprise to do so.

Thus, there exists a need for assisted management of exceptions encountered by a business process.

### SUMMARY

Described herein are various methods and tools for the assisted management of business process exceptions.

In one aspect, a computer-implemented method of handling exceptions in a business process comprises several steps, such as identifying an exception in a business process, classifying the exception as being of a particular exception type, allocating the exception to a user or group of users, investigating the exception, and resolving the exception.

In other aspects, a business process exception management system comprises several components, such as an information store that contains the domain ontology, several different types of rules relating to exception identification, exception classification, and exception allocation, exception investigation and resolution process models, an exception monitor, a rule engine, and a process engine. In another aspect, the system also comprises an ontology modeler to construct the domain ontology, a rule builder to construct the different types of rules, and a process modeler to construct the process models.

In yet another aspect, a computer-implemented method of handling a business process exception comprises establishing a business domain ontology, creating exception handling rules/processes based on the business domain ontology, and implementing the exception handling rules/processes in a business process exception management system.

Additional features and advantages will become apparent from the following detailed description of illustrated embodiments, which proceeds with reference to accompanying drawings.

### BRIEF DESCRIPTION OF THE DRAWINGS

FIG. 1 is a block diagram showing an exemplary knowledge-intensive business process system.

FIG. 2 is a block diagram illustrating the interaction between a business process and an exception management process.

FIG. 3 is a flow diagram showing an exemplary runtime flow of an exception management process.

FIG. 4 is a block diagram showing an exemplary exception management system architecture that comprises a knowledge base, runtime components, and system agents.

FIG. 5 is a flow diagram showing an exemplary exception management system architecture at runtime.

FIG. 6 is a diagram illustrating a screenshot of an exemplary domain ontology.

FIG. 7 is a flow diagram showing an exemplary process model used to resolve a Stock Transaction Reconciliation Exception whose Exception Type is Missing Ledger Stock Transaction.

FIG. 8 is a block diagram showing an exemplary exception monitor system having multiple queues.

FIG. 9 is a block diagram showing a generalized example of a suitable computing environment in which the following described embodiments may be implemented.

### DETAILED DESCRIPTION

### Exemplary Business Processes

A business process is usually defined as a sequence of activities performed by roles in the business, resulting in an end-deliverable for customers of the business. Business processes enable the organization to successfully deliver its products and services. Each business process has inputs, methods and outputs. A business process can be part of a larger, encompassing process and can comprise other business processes that have to be included in its methods and can cut across organizational units.

Business processes form the core differentiation for organizations, because the sequence of activities is typically unique to every organization. Repeatable and well-engineered business processes lead to operational excellence in an organization. Optimization of business processes is hence gaining importance in the industry.

### Exemplary Knowledge-Intensive Business Processes

Certain categories of business processes are not very well-structured. These are usually executed by people who need to be knowledgeable in the domain. These processes usually get overlooked in process re-design and improvement programs.

Knowledge-intensive processes typically rely on specialized professional expertise, continuous learning, and transformation of information. They are usually performed by knowledge workers with a high degree of expertise and experience. Knowledge workers usually enjoy a high degree of empowerment in making decisions on how they perform their activities and to develop new ways of performing their activities as their process knowledge increases. They typically perform these activities in a fluid, unconscious manner, rather than discrete steps. It is difficult to describe and document them in process terms. Knowledge-intensive business processes may have some of the following exemplary characteristics:
They can involve a creative element, that is, their sequence of activities cannot be fully predefined
The overall process description can typically be given at an abstract level
They may involve complex process with numerous steps and agents
They contain at least a few central decision steps which require personal judgment based on experience and comprehensive historical knowledge

The following exemplary attributes are some of the possible attributes for describing knowledge intensiveness and complexity of business processes:
Contingency—a number of outcomes based on chance events and environmental factors
Decision scope—the number of choices and possibilities for an agent (participant)
Agent innovation—the creativity and innovation that may be required for performing tasks in the process
Knowledge half-life—obsolescence and relevance of process-related knowledge
Agent impact—the degree to which a process's outcome depends on an agent's skill and performance
Learning time—the time typically needed to master a process
   In addition to the exemplary attributes listed above, the complexity of business processes can be defined in terms of additional attributes, such as the number of process steps and the number of agents in the process, interdependencies between steps and between agents, and dynamic sequencing of steps based on events.

On classifying business process along the dimensions of knowledge intensiveness and complexity, processes falling under the categories of weak knowledge intensity and low process complexity like order entry and fulfillment can be handled by conventional process design and IT automation techniques. However, processes with strong knowledge intensiveness such as insurance policy underwriting and exception handling often need a different approach.

### Exemplary Design Considerations for Handling Knowledge-Intensive Processes

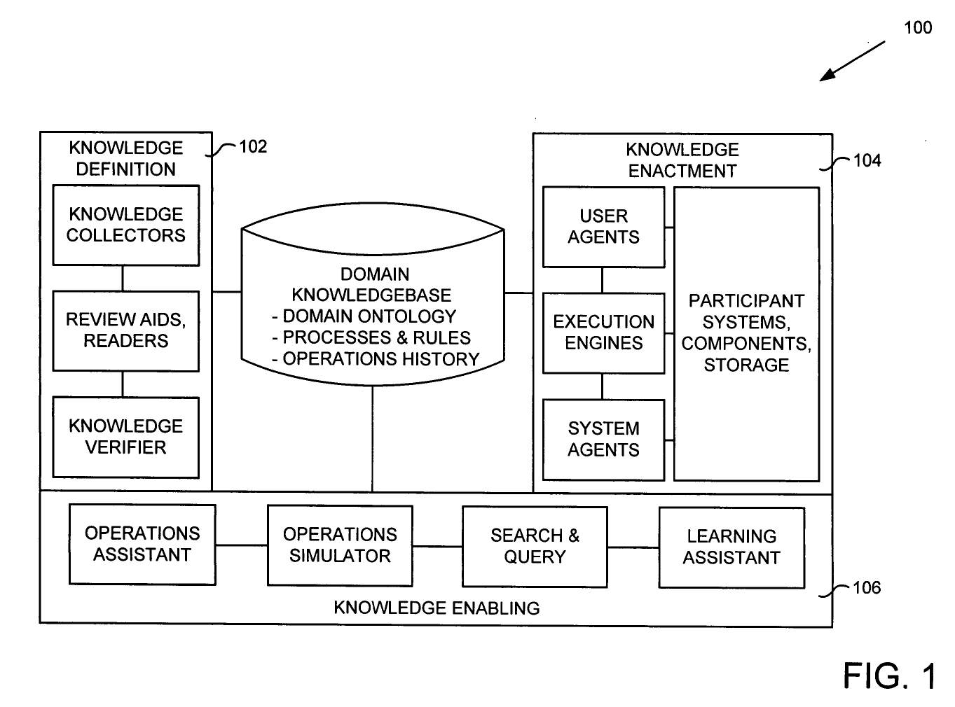

Systems intended to handle knowledge-intensive business processes can often be designed using a common design approach, such as implementing the exemplary knowledge-intensive business process system 100 shown in FIG. 1. Systems for automating such processes often can be seen as having some of the following three exemplary parts:
Knowledge definition 102 for capturing knowledge regarding the processes
Knowledge enactment 104 for orchestrating the processes based on the defined knowledge
Knowledge enabling 106 for associated functions such as learning, search and query, and simulation

An exemplary IT system to address at least some of the above requirements can involve the following:
Knowledge capture—capture of domain knowledge (practices and process steps) using ontology classes, rule representation languages, decision trees, and process models
Knowledge enactment—use of rule engines and workflow systems to interpret the practices and orchestrate the processes
Knowledge enabling—applications for enabling the use of knowledge, such as an information assistant to provide context-based help

In knowledge enactment, activities involving retrieval of information from existing systems or decisions that are well-defined can be assigned to systems for processing. Activities involving human intervention and decisions which are complex can be assigned to experts. The system can recommend decisions based on the knowledge base and capture the decisions and continuously learn in the form of an information assistant which observes the workflow and information retrieval.

### Exemplary Exception Management System

A business process exception is generally defined as a transaction that falls outside the range of transactions that are handled by an organization's business processes. An exception is a condition or event that triggers the need for investigation and possible resolution. For example, an error or inconsistency in values is discovered. As another example, a threshold value is met (e.g., a maximum dollar amount or a maximum transaction frequency for a given transaction).

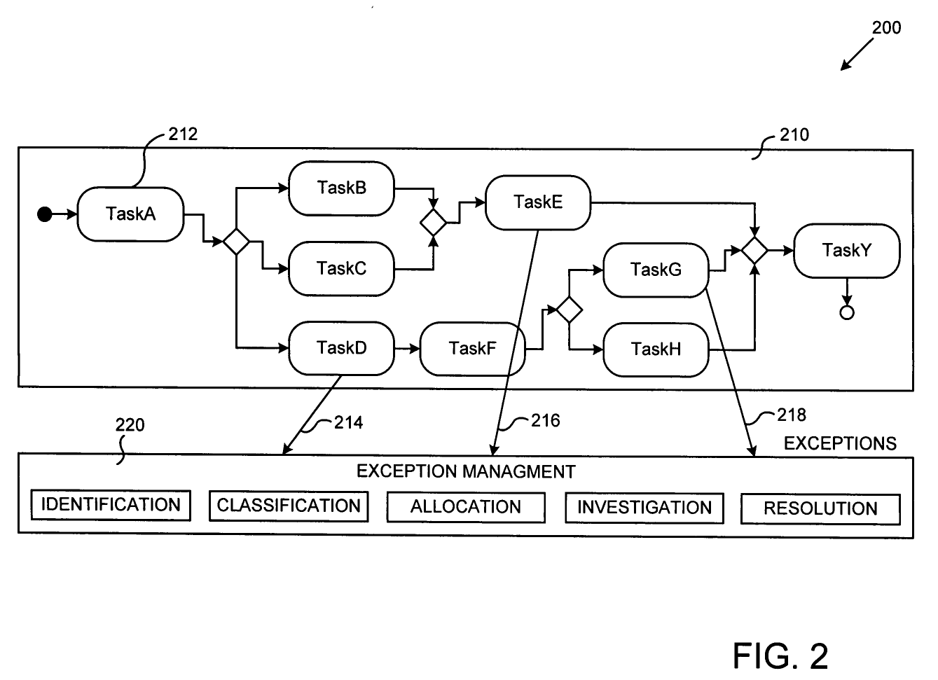

In this example, an exemplary exception management system implemented in a financial securities domain is illustrated. Those skilled in the art will appreciate, however, that the exemplary architecture is generic and can be used to implement any similar process. The need for an exception management system 200 will be understood with reference to FIG. 2. A business process 210 requires the execution of a sequence of tasks (e.g., TaskA 212). A triggering condition in the execution of the tasks for certain scenarios of user inputs can result in exceptions (e.g., exceptions 214, 216, and 218). These exceptions can be processed by an exception management system 220 to enable successful execution of the tasks and, as a result, the business process 210. In the exemplary exception management system 220, an exception is identified, classified, allocated, investigated, and resolved.

The types of exceptions that need to be handled depend on the business of the enterprise and the execution of the various steps in the life-cycle of each exception type involves knowledge that is very specific to the enterprise.

Exception management is usually enterprise-specific and highly dependent on an expert's knowledge of the domain, including processes and systems involved. Thus, exception management is usually classified as being knowledge-intensive.

### Exemplary Runtime Flow of an Exception Management Process

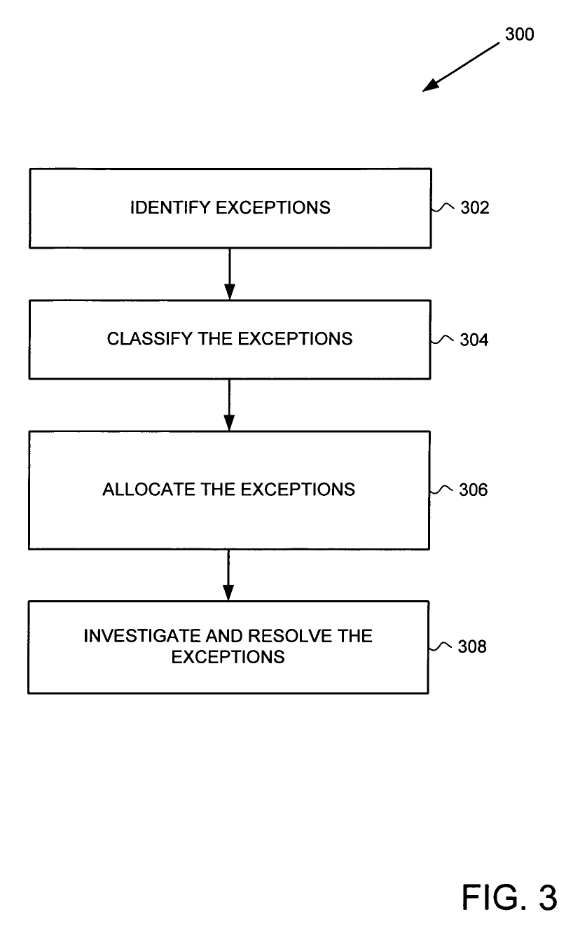

FIG. 3 illustrates an exemplary runtime flow 300 of an exception management process, such as the one that can be implemented by an exception management system, such as the exception management system 220 in FIG. 2.

At 302, exceptions are identified. Exception identification typically involves identifying those transactions that need to be flagged as being exceptions. The basis for the identification of exceptions is usually very specific to an enterprise. A transaction that needs to be flagged as an exception by an enterprise might not be an exception for another enterprise.

At 304, the identified exceptions are desirably classified based on a set of classification rules. Exception classification is typically the process of tagging an exception with a particular type. The type determination is usually done based on the values of certain fields in the exception transaction.

At 306, the classified exceptions are desirably allocated. Ownership of the classified exceptions is assigned to users or groups of users based on a set of allocation rules. Exception allocation, for investigation and resolution, is typically based on the organization structure. Exceptions of a particular type or those originating from a particular system or belonging to a specific region of a company's business might need to be assigned to specific individuals or operational teams.

At 308, the assigned exceptions are desirably investigated and resolved. Exception investigation and resolution can comprise the process of having experts identify a root cause of an exception and take the necessary steps to resolve the exception. Alternatively, a set of computer processes or some combination of user interaction and computer processes can perform the investigating and/or resolving of an exception.

Steps involved in exception investigation and resolution may differ based on the exception type. An expert or computer process responsible for executing a particular step often looks at data present in various systems within the enterprise and data from partners and/or customers. The set of systems which provide this data usually differ based on the type of exception. Enterprises often have a myriad of systems implementing business processes and, thus, experts who handle exceptions use their knowledge of systems relevant to each exception type to process the exception.

### Exemplary Architecture of an Exception Management System

The architecture of an exemplary system implementing a knowledge-intensive business process (e.g., an exception management process) desirably makes provisions for capturing knowledge that is specific to the business process. Such a system also desirably provides for implementing applications that make use of this knowledge. For purposes of illustration, consider examples from the financial securities domain. The financial securities domain usually involves various business processes such as trading, accounting, settlement, etc. Also, there are typically various entities involved (e.g., Asset Managers, Custodians, Sub-Custodians, and Brokers/Dealers) in these financial securities processes. There are often various systems (e.g., trading systems, ledger systems, settlement systems, and/or reconciliation systems) that participate in the fulfillment of these business processes. One such system is a computer-implemented reconciliation system that is responsible for reconciliation of transactions and positions related to stocks and transactions and balances related to cash coming in from an external source, such as a computer-implemented trading system and a computer-implemented balance system, with data obtained from a computer-implemented internal ledger system.

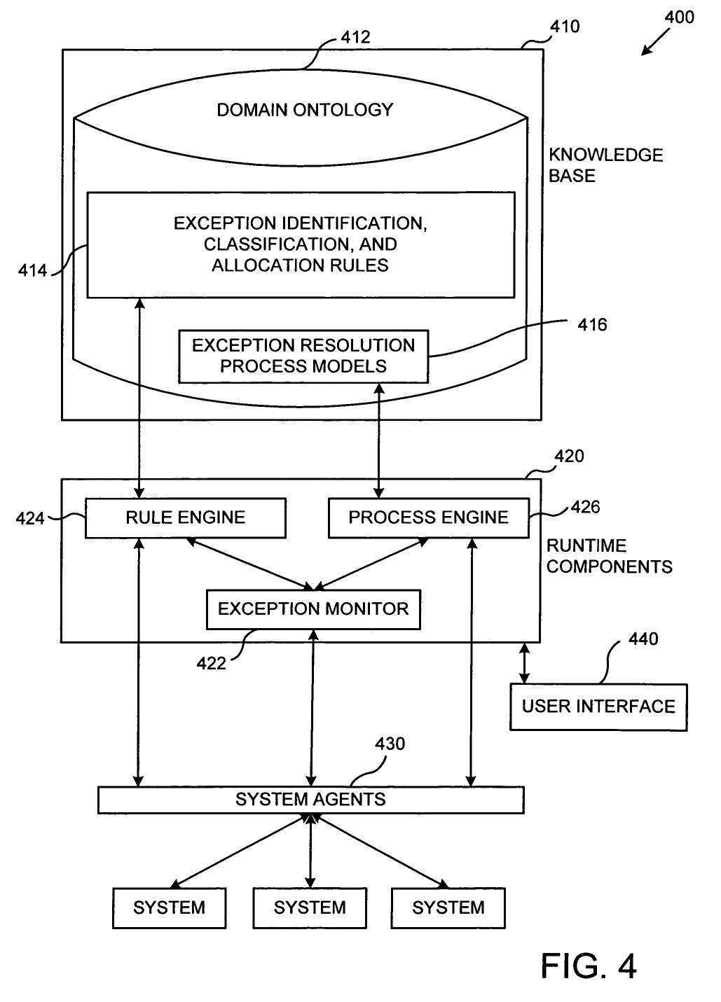

Reconciliation is typically done by the various parties involved in a given trade. Exceptions can occur when there is a mismatch between data (e.g., transactions, positions, and balances) recorded in the ledger system and that received from the trading system. These exceptions desirably are investigated and resolved to ensure that processing proceeds to the next stage in the order fulfillment process. An effective exception management architecture desirably captures knowledge to be used in investigating and resolving an exception in a knowledge base and implements application components that use the knowledge base to investigate and resolve exceptions. FIG. 4 illustrates one such exemplary exception management system architecture 400 that comprises a computer-implemented knowledge base 410 having components used for electronically storing knowledge of exceptions and a set of computer-implemented runtime components 420 that use the captured knowledge to investigate and resolve exceptions.

### Exemplary Exception Management System Architecture at Runtime

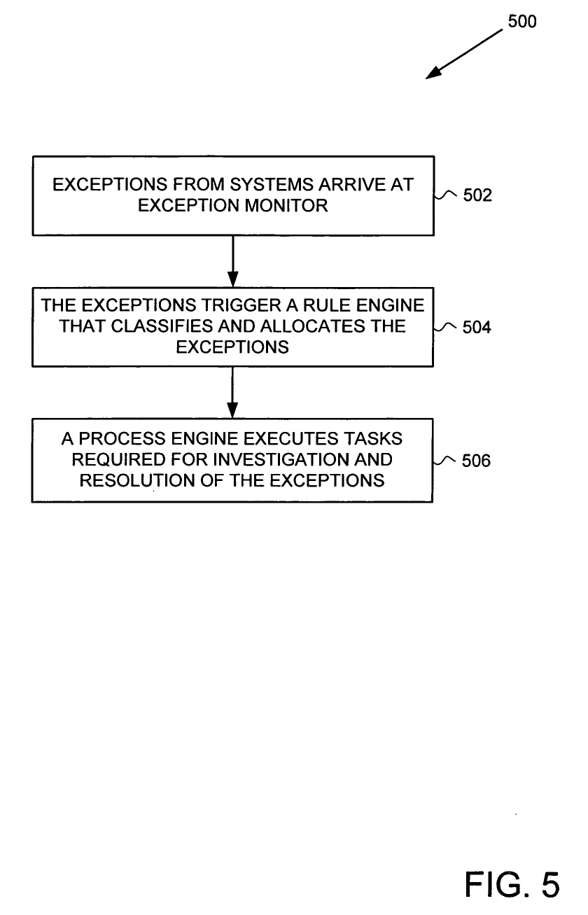

FIG. 5 illustrates an exemplary flow 500 of an exception management system architecture, such as the exception management system architecture 400 of FIG. 4, at runtime.

At 502, exceptions from systems arrive into an exception monitor (e.g., the exemplary exception monitor 422). The exceptions might be sent from system agents (e.g., the exemplary system agents 430).

At 504, the incoming exceptions recognized by the exception monitor result in triggering a rule engine (e.g., the exemplary rule engine Error! Reference source not found.24), such as in a computer processor for processing the rules, that desirably classifies the exceptions and allocates them to specific owners (e.g., to individuals or teams). The rule engine may query a domain ontology (e.g., the exemplary domain ontology 412) for information during the classification, and allocation of the exceptions.

At 506, a process engine (e.g., the exemplary process engine 426) executes tasks that are required for investigating and resolving the exceptions based at least in part on previously-created process models (e.g., the exemplary process models 416). The process engine may query the domain ontology for information during execution of the tasks.

### Exemplary Ontology

An ontology is generally a working model of entities and interactions between the entities either generically or in some particular domain of knowledge or practice. An ontology may take a variety of forms, but it will usually include a vocabulary of terms and some specification of their meaning. This typically includes definitions and an indication of how concepts are inter-related, which collectively impose a structure on the domain and constrain the possible interpretations of terms. One definition of an ontology is the specification of conceptualizations, used to help programs and humans share knowledge, where a conceptualization is the couching of knowledge about the world in terms of entities (e.g., things, the relationships they hold, and the constraints between them), and a specification is the representation of such a conceptualization in a concrete form. One step in such a specification is the encoding of a conceptualization in a knowledge representation language. A desirable goal is to create an agreed-upon vocabulary and semantic structure for exchanging information about the domain. The main components of an ontology are usually concepts, relations, instances and axioms. A concept typically represents a set or class of entities or “things” within a domain. Relations usually describe the interactions between concepts or a concept's properties. Instances are generally the “things” represented by a concept. Finally, axioms are usually used to constrain values for classes or instances.

### Exemplary Knowledge Base

The exemplary knowledge base 410 of FIG. 4 comprises a domain ontology 412, a set of rules 414 related to identifying, classifying, and allocating exceptions, for instance, and a set of process models 416 for investigating and resolving exceptions. The knowledge base 410 is built using knowledge obtained from a set of experts who are involved in handling exceptions at different stages of exception management.

### Exemplary Domain Ontology

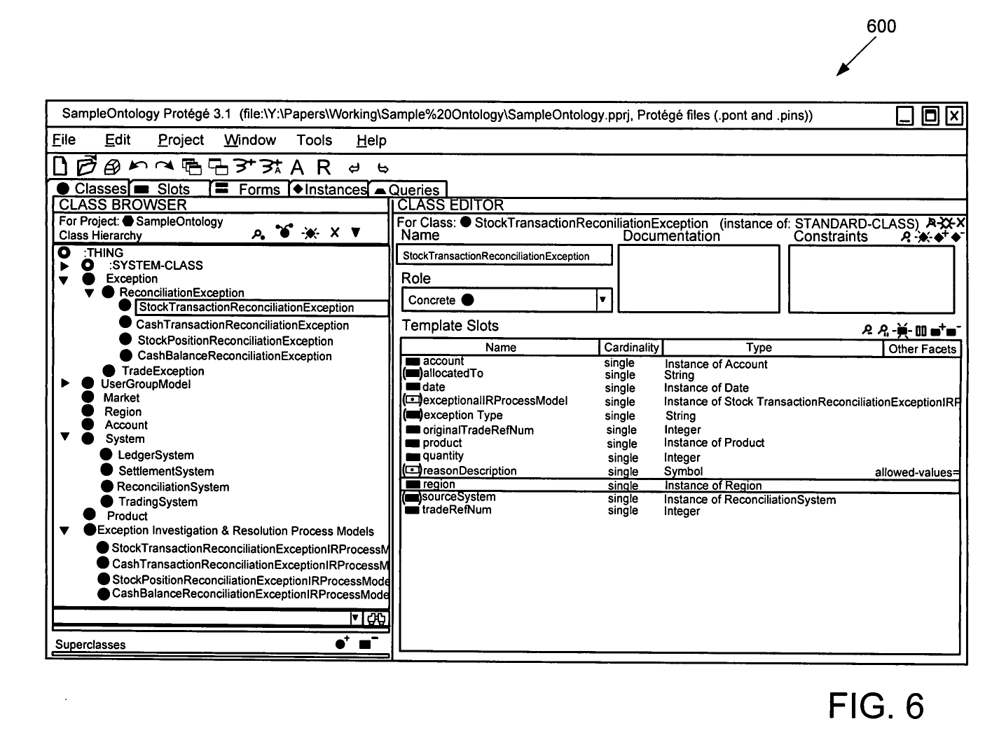

The set of concepts and relationships between concepts in the business domain along with specific instances of concepts and relationships constitute the domain ontology 412 of FIG. 4. An exemplary domain ontology 600 for the financial services domain is shown in FIG. 6. A desirable form of domain ontology comprises electronic storage media (e.g., computer memory or disks) for electronically storing the concepts and relationships. There are various kinds of exceptions that can occur. A hierarchy of exceptions can be captured and stored in the domain ontology 600. The systems that participate in the various business processes can be modeled along with details of the different operation user groups responsible for managing exceptions. Various other concepts in the domain are also modeled in the domain ontology. In addition, the ontology captures the relationships between the various concepts.

Once the ontology definition is complete, the instance information for some of the concepts can be captured. For example, instances of systems and user groups captured in the ontology can be used by runtime components to identify the specific system (and associated attributes, such as version, IP address, and operating platform) that an exception originates from, the process it corresponds to, and other related attributes that are required for processing the exception.

### Exemplary Exception Identification, Classification, and Allocation Rules

The identification, classification, and allocation of exceptions can be based on certain rules, such as the set of rules 414 in FIG. 4. Such rules can be stored electronically. Various systems in an enterprise can generate exceptions, and the logic used for identifying exceptions is usually very specific to each process and/or system in an enterprise. For example, a computer-implemented reconciliation system often flags or generates exceptions when it doesn't find a match between transaction data (e.g., stock or cash transaction data) present in internal ledger systems with the data obtained from an external party. The logic for identifying an exception is often implemented in a computer-implemented system that flags or generates the exception.

When an exception management system receives exceptions generated by various systems, the exceptions are desirably classified. The classification of exceptions often involves electronically tagging or identifying each exception based on certain rules. Once the domain ontology has been modeled, such exception classification rules can be expressed formally using elements of the domain ontology. A sample classification rule that can be expressed in the C Language Integrated Production System (CLIPS) is shown below in Table 1. The CLIPS example is shown because of its support for frame-based knowledge bases with COOL (CLIPS Object-Oriented Language). However, the rule can be expressed in other languages as well.

TABLE 1

```
(defrule ClassifyStockTransactionReconciliationException
?ExceptionObj <− (object (is-a
StockTransactionReconciliationException))
  (test(eq (send ? ExceptionObj get-reasonDescription) “Ledger
Transaction Not Found” ))
=>
    (send ?ExceptionObj put -exceptionType
    “MISSING_LEDGER_STOCK_TX”)
```

In the example, the classification rule checks for an occurrence of a “Ledger Transaction Not Found” string in the reason description. If the reason description matches the string, the exception type is classified as Missing Ledger Stock Transaction.

The classified exception is desirably allocated to users or user groups responsible for resolving exceptions. Allocation rules, such as the sample allocation rule shown below in Table 2, are desirably electronically captured in the knowledge base 410. The user or user group to whom the exception is allocated usually owns (e.g., is responsible for) the exception and is thus responsible for resolving the exception. An enterprise may have a specific organizational structure for dealing with exceptions of various types. For example, Stock Transaction Reconciliation Exceptions of type “Missing Ledger Stock Transaction” belonging to a particular region may need to be allocated to the person or team responsible for addressing such exceptions for the region. Such policies can be expressed formally using rules such as the sample allocation rule in Table 2.

```
TABLE 2
(defrule AllocateApacStockTransactionReconciliationException
?ExceptionObj <− (object (is-a
StockTransactionReconciliationException))
  (test(eq (send ? ExceptionObj get-exceptionType)
“MISSING_LEDGER_STOCK_TX”)) (test (eq (send ?
(send ? ExceptionObj get-region) get-regionName) APAC))
=>
    (send ?ExceptionObj put-allocatedTo STOCK_APAC_DESK1)
```

In the example, the allocation rule checks for the type and region name of the exception. If the exception is of the type Missing Ledger Stock Transaction and the region in which the exception has occurred is Asia Pacific, the exception is allocated to STOCK_APAC_DESK1, which is an instance of the concept ExceptionOwner in the domain ontology. The interrelationship of the exception, product, market, and region concepts captured in the domain ontology enables easy editing of allocation and classification rules.

### Exemplary Exception Investigation and Resolution Process Models

Once an exception has been assigned to an owner, the exception is usually subjected to a sequence of steps to be investigated and resolved. The sequence of steps can be captured as a sequence of tasks using a process model. A task may be manual (e.g., a person performs some actions) or automated (e.g., a software agent looks up some information in a system). Based on the outcome of each task, the next task to be executed can be determined. Irrespective of whether a particular task is manual or automated, the business domain ontology can be used as an effective aid for capturing information that is needed for the execution of tasks.

BPMI.org has defined the Business Process Modeling Language (BPML) standard for modeling and defining processes. Process models can be captured using BPML. Use of BPML allows for the modeling of both manual and automated tasks in a process. When a process is modeled, each task can be associated with the software function that performs the task. For example, a manual task can be associated with a user interface and an automated task can be associated with a system agent. When a process engine orchestrates such a process, it can invoke the software function that is associated with the current task. When a manual task is encountered, the user interface can be displayed to the concerned user, such that the user can input the necessary information after performing the manual task. Similarly, when an automated task is encountered, the corresponding system agent can be invoked so that it can fetch the relevant data from a system. The use of a domain ontology can help in formally defining the information to be displayed to a user for performing a manual task and the information required by a software agent for performing an automated task. When the process executes, instances of the domain ontology concepts can be used as actual values for the manual or automated tasks.

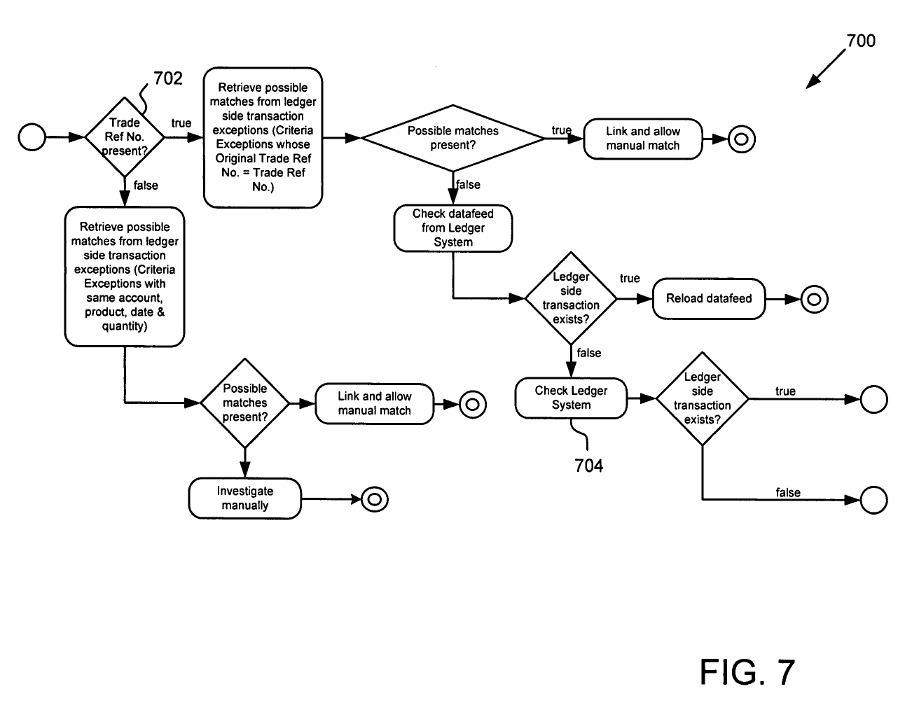

FIG. 7 illustrates an exemplary process model 700 for the investigation and resolution of a Stock Transaction Reconciliation Exception having exception type “Missing Ledger Stock Transaction.”

A domain ontology can be used to express the information required for executing the conditions/tasks. For example, the condition 702 labeled as “Trade Ref No. Present?” can be represented formally using an expression referring to ontology elements such as “StockTransactionReconciliationException.tradeRefNum=NULL?” Similarly, the task 704 labeled “Check Ledger System” can be mapped to a software agent that accepts as inputs “StockTransactionReconciliationException.sourceSystem.ledgerSystem,” “StockTransactionReconciliationException.tradeRefNum,” etc. When a process engine (e.g., exemplary process engine 426 in FIG. 4) orchestrates the process, instances of the required ontology elements can either be passed to the process engine or the process engine can retrieve the instances as needed. For example, when the process engine executes the task 704 “Check Ledger System,” in one specific exemplary approach, it would need to know the actual ledger system to check and the trade reference number of the transaction to check for. This information can be retrieved from the instance information stored in the domain ontology.

### Exemplary Exception Management Runtime Components

Exemplary runtime components 420 in FIG. 4 can use the knowledge base 410 to manage exceptions. The runtime components 420 can use the knowledge base and interact with users and systems (e.g., through use of a user interface 440 and system agents 430) to investigate and resolve such exceptions.

### Exemplary Exception Monitor

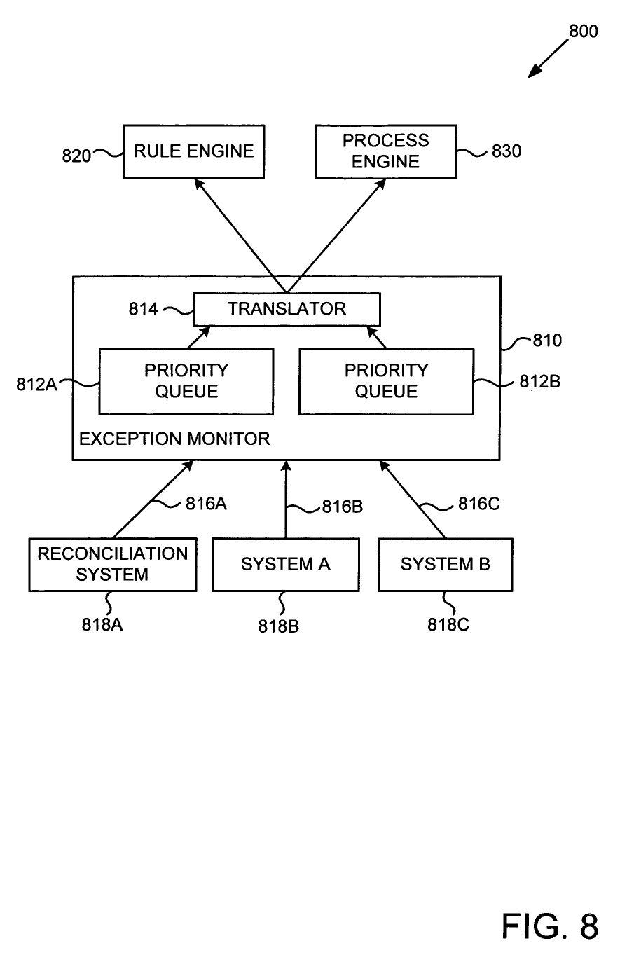

The exception monitor 422 of the exemplary exception management system architecture 400 of FIG. 4 is responsible for prioritizing exceptions it receives from multiple systems, as well as triggering the rule engine 424 and process engine 426. A detailed exemplary exception monitor is shown in FIG. 8, which illustrates an exemplary exception monitor system 800 that comprises an exception monitor 810 having multiple queues 812A-B. Exceptions 816A-C from multiple systems 818A-C are sent to the appropriate queues 812A-B based on their priority. A translator 814 picks up the exceptions 816A-C from the queues 812A-B. Exceptions in XML format are translated to instances of appropriate exception classes as defined in the domain ontology. An instance of the ontology class created by the translator 814 triggers a rule engine 820 and/or a process engine 830 for further steps to be taken regarding the exception.

### Exemplary Rule Engine

The rule engine 424 of the exemplary exception management system architecture 400 of FIG. 4 runs the respective classification and allocation rules. The domain ontology 412 can be used by the rule engine 424 to create a set of facts or objects in its working memory. Hence, in this example, it desirably uses a rule engine that supports frame/object-based knowledge elements. For instance, CLIPS is an exemplary rule engine that supports frame-based object and instance definitions. Exception instances can be created and inserted into a working set of the rule engine 424. The rule engine 424 desirably classifies exceptions and allocates them to an exception owner. The classified and allocated exceptions can be stored in an exception management database.

Rules composed using an ontology usually need to be executed in a rule engine. That the rule engine 424 supports a frame-based knowledge base is typically preferred.

### Exemplary Process Engine

The process engine 426 of the exemplary exception management system architecture 400 of FIG. 4 picks up exceptions and executes the relevant process. The process might have tasks that need human intervention. An automated task can be executed by the process engine 426 using agents. The activities in the process engine 426 can be authored using the domain ontology 412. Hence, the process engine 426 can constantly interface with the domain ontology 412 to execute the tasks in the process.

The activities involved in a process should be orchestrated based on the exception that needs to be investigated and resolved. A process engine that provides support for execution of manual/system activities can help. For example, a Business Process Modeling (BPM) or Workflow product can serve as a process engine. The tasks that use ontology descriptions can be translated to the Business Process Modeling Language (BPML). An ontology access Application Programming Interface (API) to allow for a process engine to execute tasks based on the ontology specification can be helpful.

Exemplary System Agents

The system agents 430 of the exemplary exception management system architecture 400 of FIG. 4 interface with various software systems that are involved in the business process. The system agents 430 are typically responsible for posting exceptions to the exception monitor 422. They can also act as an interface to the process engine 426 and the rule engine 424 when additional inputs are required from the system for rule or task execution. Details of the systems and its respective system agents can be stored in the domain ontology 412. The rule engine 424 or the process engine 426 can invoke one of the system agents 430 and query for required system information. The agent can provide the relevant data in an XML format. The system agents 430 can be platform- and system-specific. For extensibility, it is preferable to have the system agents 430 as web services so that the rule engine 424 or the process engine Error! Reference source not found.26 can follow a generic implementation for interfacing with the system agents Error! Reference source not found.30.

### Exemplary Ontology Editor

A frame-based ontology representation language can provide a way of modeling a business domain ontology. An editor such as Protege (an open source ontology/knowledge-based editor) that provides functionality for visual modeling of frame-based ontology can be used for modeling an ontology. Such an editor can provide an intuitive and powerful way of modeling concepts and inter-relationships between the concepts.

### Exemplary Ontology Representation Language

Once a business ontology has been modeled using frame-based ontology representation techniques, it can be serialized for aiding in machine interpretation. Use of the Extensible Markup Language (XML) represents a standards-based serialization technique. The World Wide Web Consortium (W3C) has recently developed standards such as Resource Description Framework (RDF) and Web Ontology Language (OWL) for representing an ontology in XML format. An ontology, once converted to such machine-interpretable standard formats, can be used by other components of an exception management system.

### Exemplary Ontology Storage

Ontology and knowledge (e.g., instances) should be stored. For some systems (e.g., an exception management system), persistence of ontology/knowledge in a relational database can provides its own advantages. An ontology middleware such as Sesame can be used for persisting/querying ontology/knowledge present in a relational database.

Exemplary Business Domain Ontology to System Meta-Data Map

Data corresponding to the instances of the business domain ontology concepts may be present in systems spread across the enterprise. Such systems have their own meta-data for representing/storing data. If a system uses a relational database for data persistence, the database scheme defines the system meta-data. The business domain ontology forms a common conceptual model of data spread across the organization. Hence, this needs to be mapped to the system meta-data so that data in heterogeneous systems can be easily referred/extracted using a common conceptual model.

Exemplary Ontology-Based Rule Builder

A business domain ontology can serve as the basis for the composition of various kinds of rules (e.g., exception identification, classification, and allocation rules). This can be achieved if a computer-implemented interface for ontology-based rule building is provided. For example, a computer-implemented ontology-based rule-building layer can be built on top of existing computer-implemented rule engines.

### Exemplary Ontology-Based Process Modeler

A business domain ontology can serve as a foundation for modeling processes (e.g., exception investigation and resolution processes). A computer-implemented layer can be built on top of existing computer-implemented process modelers to enable the writing of task executions using the computer-implemented domain ontology.

### Exemplary Computing Environment

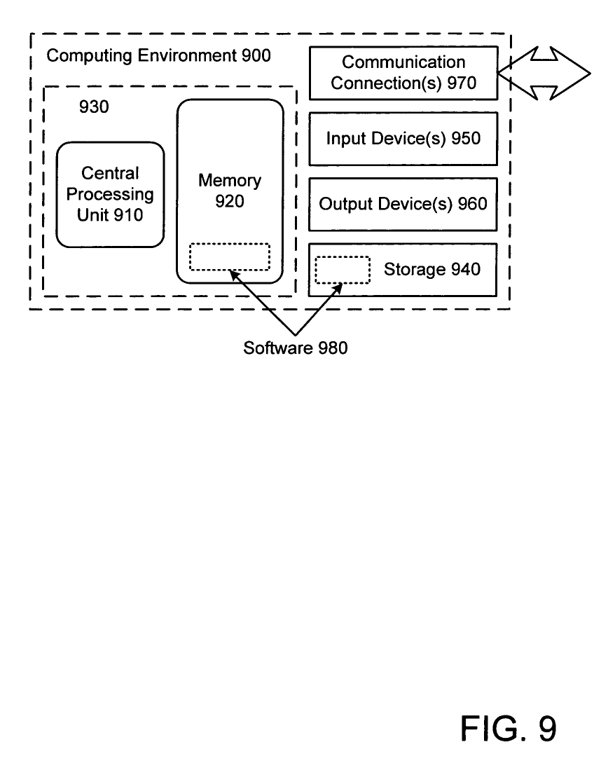

FIG. 9 illustrates a generalized example of a suitable computing environment 900 in which described embodiments may be implemented. The computing environment 900 is not intended to suggest any limitation as to scope of use or functionality of the disclosed technology, as it may be implemented in diverse general-purpose or special-purpose computing environments.

With reference to FIG. 9, the computing environment 900 includes at least one central processing unit 910 and memory 920. In FIG. 9, this most basic configuration 930 is included within a dashed line. The central processing unit 910 executes computer-executable instructions and may be a real or a virtual processor. In a multi-processing system, multiple processing units execute computer-executable instructions to increase processing power and as such CPU 930 can be running simultaneously with other processors. The memory 920 may be volatile memory (e.g., registers, cache, or RAM), non-volatile memory (e.g., ROM, EEPROM, or flash memory), or some combination of the two. The memory 920 stores software 980 implementing the described methods of assisted business process exception management.

A computing environment may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The storage 940 may be removable or non-removable, and can include magnetic disks, magnetic tapes or cassettes, CD-ROMs, CD-RWs, DVDs, or any other medium which can be used to store information and which can be accessed within the computing environment 900. The storage 940 stores instructions for the software 980 implementing methods of automated relationship traceability between software design artifacts.

The input device(s) 950 may be a touch input device such as a keyboard, mouse, pen, or trackball, a voice input device, a scanning device, or another device that provides input to the computing environment 900. For audio, the input device(s) 950 may be a sound card or similar device that accepts audio input in analog or digital form, or a CD-ROM reader that provides audio samples to the computing environment. The output device(s) 960 may be a display, printer, speaker, CD-writer, or another device that provides output from the computing environment 900.

The communication connection(s) 970 enable communication over a communication medium to another computing entity. The communication medium conveys information such as computer-executable instructions, compressed graphics information, or other data in a modulated data signal.

Computer-readable storage media are any available tangible media that can be accessed within a computing environment. By way of example, and not limitation, with the computing environment 900, computer-readable media includes memory 920, storage 940, or some combination thereof.

The various tools and systems such as, but not limited to, a rule engine (e.g., the exemplary rule engine 424 of FIG. 4), a process engine (e.g., the exemplary process engine 426), and an exception monitor (e.g., the exemplary exception monitor 422) described herein for implementing the methods of assisted business process exception management are in one aspect a machine comprising a processor (e.g., CPU 910 of FIG. 9) programmed according to computer-executable instructions represented at least in part in memory 920 and storage 940 to execute the functionality represented therein.

Having described and illustrated the principles of the disclosed technology with reference to the illustrated embodiments, it will be recognized that the illustrated embodiments can be modified in arrangement and detail without departing from such principles. Elements of the illustrated embodiment shown in software may be implemented in hardware and vice versa. Also, the technologies from any example can be combined with the technologies described in any one or more of the other examples. In view of the many possible embodiments to which the principles of the disclosed technology may be applied, it should be recognized that the illustrated embodiments are examples and should not be taken as a limitation on the scope of the disclosed technology. For instance, various components of systems and tools described herein may be combined in function and use. We therefore claim as our invention all subject matter that comes within the scope and spirit of the following claims.

We claim:

1. A method of handling exceptions in a business process, the method comprising:
a computer-implemented act of identifying an exception in a business process based at least in part upon a plurality of identification rules expressed in terms of a domain ontology;
a computer-implemented act of classifying the exception as being at least one of a plurality of exception types, wherein the computer-implemented act of classifying the exception is based at least in part on a plurality of classification rules expressed in terms of the domain ontology;
a computer-implemented act of allocating the exception to at least one user based at least in part on a plurality of allocation rules expressed in terms of the domain ontology; and
investigating and resolving the exception based at least in part on the computer-implemented act of classifying the exception and the computer-implemented act of allocating the exception, wherein the act of investigating and resolving the exception is based at least in part on a plurality of investigation and resolution process models.

2. The method of claim 1, wherein the act of investigating and resolving the exception comprises using a combination of computer-implemented investigation and resolution actions and user interaction.

3. The method of claim 1, wherein the computer-implemented act of classifying the exception comprises assigning one of the plurality of exception types to the exception.

4. The method of claim 1, wherein the computer-implemented act of allocating the exception to at least one user comprises assigning responsibility for the exception to the at least one user.

5. The method of claim 2, wherein the computer-implemented investigation and resolution actions are performed by at least one system agent.

6. The method of claim 2, wherein the user interaction is performed by at least one human expert.

7. The method of claim 3, wherein the act of investigating and resolving the exception comprises a plurality of acts having an order determined by the assigned one of the plurality of exception types.

8. The method of claim 1, wherein the at least one user comprises a group of users belonging to an operational team.

9. The method of claim 1, wherein the act of investigating and resolving the exception comprises determining at least one root cause of the exception.

10. A business process exception management system, comprising:
a computer-implemented information store comprising a domain ontology, a plurality of electronically-retrievable exception investigation and resolution process models, a plurality of electronically-retrievable exception identification rules, a plurality of electronically-retrievable exception classification rules, and a plurality of electronically-retrievable exception allocation rules;
a computer-implemented exception monitor operable to receive at least one business process exception;
a computer-implemented rule engine operable to be triggered by the computer-implemented exception monitor to classify and allocate the at least one business process exception; and
a computer-implemented process engine operable to be triggered by the computer-implemented exception monitor to execute a plurality of tasks related to investigation and resolution of the at least one business process exception.

11. The business process exception management system of claim 10, further comprising a computer-implemented rule builder operable to build the plurality of electronically-retrievable exception identification rules, the plurality of electronically-retrievable exception classification rules, and the plurality of electronically-retrievable exception allocation rules.

12. The business process exception management system of claim 10, further comprising a computer-implemented process modeler operable to construct the plurality of electronically-retrievable exception investigation and resolution process models.

13. The business process exception management system of claim 10, further including a plurality of computer-implemented system agents operable to post the at least one business process exception to the exception monitor.

14. The business process exception management system of claim 13, wherein the computer-implemented exception monitor comprises a plurality of priority queues operable to receive the at least one business process exception posted by the plurality of computer-implemented system agents.

15. The business process exception management system of claim 14, wherein the computer-implemented exception monitor further comprises a translator operable to translate the at least one business process exception to an instance of a concept stored in the computer-implemented information store.

16. A method of handling a business process exception, comprising:
a computer-implemented act of establishing a business domain ontology for a business domain by capturing a plurality of concepts in the business domain and capturing a plurality of relationships between the plurality of concepts in the business domain;
a computer-implemented act of capturing a plurality of exception handling rules and processes based on the business domain ontology;
a computer-implemented act of implementing the plurality of exception handling rules and processes in a business process exception management system to handle a business process exception; and
investigating and resolving the business process exception based at least in part on a plurality of business process exception investigation and resolution models.

17. The method of claim 16, wherein the computer-implemented act of implementing the plurality of exception handling rules and processes comprises using a computer-implemented rule engine and a computer-implemented process engine operable to handle the business process exception.

18. The method of claim 16, wherein the act of investigating and resolving the business process exception comprises a computer-implemented act of implementing a plurality of system agents to perform at least one automated business process exception investigation and resolution task.

19. A tangible computer-readable medium having stored thereon computer-executable instructions for performing a method of assisted business process exception management, the method comprising:
using a domain ontology in identifying at least one exception in at least one business process;
using the domain ontology in classifying the at least one exception as corresponding to at least one of a plurality of exception types, wherein the classifying is based at least in part on at least one classification rule;
using the domain ontology in allocating the at least one exception to at least one recipient based at least in part on at least one allocation rule; and
using the domain ontology in investigating and resolving the at least one exception based at least in part on at least one investigation and resolution process model.
